(19) United States
(12) Patent Application Publication
(10) Pub. No.: US 2002/0184039 A1
(43) Pub. Date: Dec. 5, 2002

(54) Radio content browser

(76) Inventors: Weibo Gong, Amherst, MA (US); Xiaohong Guan, Lafayette, CA (US); Changchun Zou, Amherst, MA (US)

Correspondence Address: Weibo Gong, 25 Sacco Dr., Amherst, MA, 01002, US

(21) Appl. No.: 10/157,070

(22) Filed: May 29, 2002

Related U.S. Application Data
(60) Provisional application No. 60/294,373, filed on May 30, 2001.

(51) Int. Cl. G10L 21/00

(52) U.S. Cl. 704/500

(57) ABSTRACT

A user-friendly radio content browser is provided so that the user can browse and selectively listen to the recorded radio program contents. Psycho acoustic audio compression algorithms are used for memory saving and audio quality preservation. Examples of simple and convenient operation mechanisms are provided.

### CROSS-REFERENCE TO RELATED APPLICATIONS

This application is entitled to the benefit of Provisional Patent Application Ser. No. 60/294,373, filed May 30, 2001.

### STATEMENT REGARDING FED SPONSORED R&D

Not Applicable.

### BACKGROUND

1. Field of Invention

This invention relates to convenient content browsing of recorded radio programs via brief sampling, specifically for car radios and general desktop or portable radio sets.

2. Discussion of Priori Art

U.S. Pat. No. 6,067,278 to Owens and Hrvatin (2000) shows incorporation of the digital recorder in the car radio. That patent proposes to record short segments of radio program content using a digital recorder when the user presses a button. That device can also be used to record the driver's own words. That device does not have the radio content browsing concept.

U.S. Pat. No. 5,787,399 to Lee et al. (1998) shows a portable recording/reproducing device where the non-sound sections of the audio signal are detected and used to separate the signal into blocks for selective playback. There is no content sampling and browsing functionality.

U.S. Pat. No. 5,696,928 to Grewe et al. (1997) shows memory chip architecture for digital storage of prerecorded audio data wherein each of the memory cells are individually addressable and shift registers are used for sorting data to be placed on the address bus and receiving data from the data bus. It's mainly about using digital memory chips to replace the recordable compact disk. There is no content sampling and browsing functionality. The circuit involves significant hardware and software and is not suitable for car radio or ordinary radio set.

U.S. Pat. No. 5,633,837 to Gantt (1997) shows an automobile radio recording system that allows a user to continuously record the radio programs onto a solid state memory and then transfer selected portions to a cassette tape or recordable compact disk. The purpose is to prevent unnecessary wear on the tape. There is no content sampling and browsing functionality.

U.S. Pat. No. 5,263,199 to Barnes et al. (1993) shows a vehicle accessory having integrally contained radio receiver and recording means for recording radio broadcasts while simultaneously recording sound emitted onto a recorder microphone. There is no content sampling and browsing functionality for the recorded radio program content.

U.S. Pat. No. 4,963,866 to Duncan (1990) shows a multi-channel digital random access recorder-player that receives an analog audio signal, converts the audio signal into a digital signal, and stores the digital signal in a memory for random access. The playback is by the memory address and there is no content sampling and browsing functionality as provided in our invention described in the following sections.

U.S. Pat. No. 4,805,217 to Morihiro et al. (1989) shows a receiving set with playback function where a receiving set is capable of recording the sound of the broadcast received, while enabling the listener to listen to the present broadcast, and of reproducing the recorded sound when requested by the listener. A digital memory device is provided for recording the detected audio signal in compressed form on the time axis. The memory device is accessed upon request by the listener and the signal read out of the memory is processed to produce a sound. There is no content sampling and browsing functionality.

In conclusion, insofar as we are aware, no radio receiver formerly developed provides browsing capability for the previously recorded content. This content browsing functionality for radio programs and the operation mechanisms are the main concepts in this invention.

### BRIEF SUMMARY OF THE INVENTION

The invention, a radio content browser, provides the functionality of browsing through previously recorded radio content for the car radio. When a user listens to the radio, s/he could select either the conventional way to listen to the current radio programs, or to listen to the sampled pieces of previously recorded radio programs. In the later selection the user can stop the browsing at a place s/he finds interesting and begin to continuously listen to the recorded content from the said place.

The invention also provides implementation ideas for user-friendly operation.

### BRIEF DESCRIPTION OF THE DRAWINGS

FIG. 1 is a perspective block diagram of the radio content browser.

FIG. 2 is a perspective front view of a car radio panel with additional radio content browser.

### DETAILED DESCRIPTION OF THE INVENTION

A key feature of this invention is the browsing functionality. Audio compression algorithms (such as MPEG layer 3 (MP3) algorithm) are used to continuously compress and record radio signal into fixed time-interval frames. For example, each recorded frame could be a 10-minute piece of a radio program. Several hours radio program can be recorded in memory (or other digital storage devices) as dozens of 10-minute frames in the order of the receiving time. When the user pushes the forward-browsing button once the radio content browser will play out the first few seconds of each recorded frame. This process is referred as sampling. This allows the user to quickly browse through the previously recorded radio program frames. When the user finds the desired piece, s/he can stop the browsing and begin to listen to the recorded content started with the said piece by pressing the said forward-browsing button once again. Examples for simplifying user's operation are introduced and will be explained in the following paragraphs.

One possible application of this invention is to integrate the content browser into the car radio device. FIG. 2 illustrates the front panel 13 of the car radio 4 which has the content browser built in. The panel can be used for both the conventional car radio operation and the radio content browser operation. The front panel 13 has the conventional display screen 12, channel auto-scan button 14, and six preset channel buttons 15a-15f, AM/FM selecting button 9, clock 8 and volume knob 7. It also contains several buttons for radio content browser: the record button 5, record indicator LED 6, forward-browsing button 11 and backward-browsing button 10.

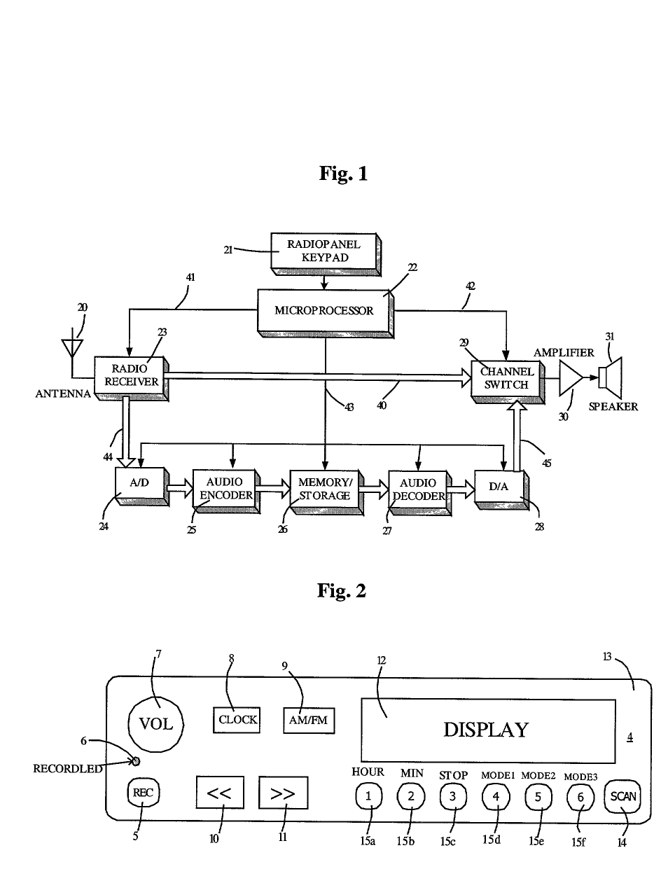

FIG. 1 is a perspective block diagram of the radio content browser in this invention. It is controlled by a microprocessor 22. The microprocessor 22 receives input commands from the radio panel keypad 21, which consists of the buttons and volume knob in shown in FIG. 2. Radio signal receiver 23 receives the radio AM/FM signal from the antenna 20 and outputs the analog audio signal to the channel switch 29 and the Analog/Digital converter 24. The A/D converter 24 converts the analog audio signal to digital signal and sends the digital signal into the audio encoder chip 25 (for example, a MP3 encoder chip). This chip encodes the digital audio signal with an audio compression algorithm and saves the compressed audio stream into the memory or other digital storage devices 26. When the user wants to browse the recorded radio programs, s/he gives command to the microprocessor 22 by pushing the forward-browsing button 11 in FIG. 2 once. This will allow the audio decoder 27 to read the compressed format audio data from the memory/storage 26. The D/A chip 28 converts the digital audio data from the audio decoder 27 into the analog audio signal and sent it to the channel switch 29. Channel switch 29 then passes the audio signal from A/D 28 to the amplifier 30 and the speaker 31 to play out the samples of the recorded signal for browsing purpose (see the next paragraph for more detailed description for browsing). When the user finds an interesting place s/he pushes the said forward-browsing button 11 once again. The microprocessor 22 will stop the sampling and begin to continually play out the recorded signal from the said place on. When the channel switch 29 selects the incoming audio signal from the radio receiver 23, the user will directly listen to the current radio program.

This invention, the radio content browser, can have several modes of recording. The default mode of operation can be automatic continuous recording during parking or driving. In this mode, the CPU controls the memory/storage device to always keep the last several hours (up to the memory/storage device limit) radio program. When the memory/storage device is full the oldest portion of the recorded program would be overwritten with the newest one.

The user can preset one of recording modes: Set a timer to record; Continuously record during parking; Record during driving, etc. The radio content browser is a low-powered equipment that can be kept on all the time similar to the car alarm system.

The panel and the operation should be simple and convenient. For example, the one-press, double-press, press-and-hold a moment on a button are used as three different commands to perform different tasks.

Audio compression algorithms other than the MP3 can be used in this radio content browser. Both flash memory and DRAM or other digital storage devices can be used for Memory 26.

The power required to sustain data on DRAM is almost negligible for the car battery. In the future, portable hard disk or CD-Writer driver can be used as large storage.

The operation of the radio content browser can have many modes. Several examples are given below. The actual implementation could have many variations. For example, instead of pressing buttons, voice recognition technique could be used.

1. Content Browsing Function:

(1) Automatic Browsing:

Press button 11 once for auto-forward scanning (namely to listen to the first few seconds of each recorded frame). Press button 10 for auto-backward scanning (most used when overshoot in forward scanning). In this mode, the radio content browser will play out the first (for example) 10-second of a recorded frame. If the user has no action on the browsing button during this period, it will automatically jump to the next or previous frame. The forward or backward browsing will keep proceeding automatically until the user finds the frame s/he is interested. Pressing the button 11 or button 10 again will start to play out the recorded program begin with the selected frame.

(2) Rough Browsing:

To avoid browsing from the beginning of the recorded radio programs every time a rough browsing function is introduced as follows. Press and hold for a moment the forward button 11 or backward button 10 to enter this function. Then press one of the channel buttons 15a to 15f. All of the recorded fixed length audio frames are equally divided into 5 groups according to time sequence. Pressing button 15a gets to the beginning of the recorded radio program. Pressing button 15f gets to the end of the recorded radio program. Pressing button 15b, 15c, 15d, 15e gets to the end of group 1, 2, 3, 4, respectively.

(3) Manual browsing:

Press button 11 twice to jump forward to the next recorded frame or press button 10 twice to jump backward to the previous frame.

2. Recording Operation:

(1) Normal Recording:

Press “record” button 5 to record the current radio channel program into the radio content browser. The recording indicator LED 6 will turn on. Press button 5 again to stop recording and turn off LED 6.

(2) Recorder Mode Setup:

Double-press “record” button 5 to enter this function. Then select mode 1 to 3 by pressing buttons 15d to 15f, respectively, or press stop button 15c to turn off the radio content browser. In mode 1 the radio content browser continuously records the radio program from the last channel the user listened to. When the memory/storage device is full the latest content will overwrites the earliest one. In mode 2 the content browser automatically turns on recording every day at the same time selected in the timer. In mode 3 the content browser turns on when the car's engine starts and begin to record the program at a preset channel. The user can also listen to other channels at the same time in this mode.

(3) Recording Frame Length Setup:

Press-and-hold “record” button 5 for a moment will enter this function. The user can setup the length of the recording frame in the radio content browser. Short frames give the user finer browsing capability but the time to sample through the content will be longer. Longer frames provide more quickly but rougher browsing. First press-and-hold “record” button 5 and then uses button 15b to adjust the frame length. The default length is, for example, 10 minutes.

3. Recording Timer Setup:

Double press (or press-and-hold) “clock” button 8 to enter timer setup function. Use the same procedure as above to setup the beginning and end time of recording. The channel to be recorded is the current radio channel. Note that usually a single press on button 8 provides the clock setup.

What is claimed is:

1. A Radio Content Browser, comprising:
a content browser that browses the content of the digitally recorded and compressed radio programs, and
a digital recording system uses DRAM or cheaper memory or other storage like hard disk, etc., and records the radio programs content into fixed length frames,
a psycho acoustic voice signal compressor such as the MP3 compressor,
a radio signal receiver (AM, FM and/or other)
whereby (a) during usage the user browses the pre-recorded radio content frames by listening to a small portion of each frame to select the desired recorded content, (b) the said user operates the said radio content browser with simple actions such as pressing a button on the panel of the said radio receiver, or using voice recognition techniques and (c) the said digital recorder records several hours of latest or timed radio programs content with psycho acoustic compression.
